(19) United States
(12) Patent Application Publication
(10) Pub. No.: US 2010/0169618 A1
(43) Pub. Date: Jul. 1, 2010

(54) IDENTIFYING CONCURRENCY CONTROL FROM A SEQUENTIAL PROOF

(75) Inventors: Ganesan Ramalingam, Bangalore (IN); Sriram Rajamani, Bellevue, WA (US); Venkatesh-Prasad Ranganath, Bangalore (IN); Kapil Vaswani, Bangalore (IN); Jyotirmoy Vinay Deshmukh, Austin, TX (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/345,857

(22) Filed: Dec. 30, 2008

(51) Int. Cl. G06F 9/44

(52) U.S. Cl. 712/220; 712/E09.004

(57) ABSTRACT

The claimed subject matter provides a system and/or a method that facilitates ensuring non-interference between multiple threads that access a shared resource. An interface can receive a portion of sequential code, wherein the portion of sequential code includes a property that is maintained and relied upon when invoked and executed by a sequential client. A synthesizer component can leverage a sequential proof related to the portion of sequential code in order to derive a concurrency control mechanism for a portion of concurrency code that maintains the property when invoked by a concurrent client, wherein the sequential proof identifies a concurrent interference at an execution point that is tolerable for the concurrent client.

### BACKGROUND

Advances in computer technology (e.g., microprocessor speed, memory capacity, data transfer bandwidth, software functionality, and the like) have generally contributed to increased computer application in various industries. In particular, microprocessors have emerged as multi-core processors which increase processing capabilities. The emergence of multi-core processors has directly influenced the increasing importance of concurrency, transaction processing, and the like.

Concurrent programs can be difficult and expensive to design, develop and debug. A key challenge in concurrent programming can be concurrency control: ensuring that execution of different threads that share resources and data do not interfere with each other. To avoid such interference, it is necessary to identify boundaries of isolation (e.g., a period when one thread's assumption about shared data is not invalidated by another thread) carefully. Furthermore, traditional approaches in regards to concurrency control often require manual identification of code regions that should be isolated. Programmers can make mistakes in identifying the boundaries of isolation, which ultimately leads to incorrect program behavior

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods that facilitate ensuring non-interference between concurrent clients using some shared resource by leveraging a sequential proof for sequential code to derive concurrent control. A synthesizer component can analyze a sequential proof related to a portion of sequential code in order to automatically and systematically generate concurrency control for particular execution points in order to adapt the sequential code to a concurrent client, setting, or environment. In general, the synthesizer component can analyze the sequential proof in order to identify predicates that are maintained at particular sequential execution points, which can be leveraged to determine a set of locks as well as places where such locks are acquired and released in the code for concurrency control.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates ensuring non-interference between concurrent clients that use some shared resource by leveraging a sequential proof for sequential code to derive concurrent control.

FIG. 2 illustrates a block diagram of an exemplary system that facilitates synthesizing concurrency control code for a concurrent client from a collection of sequential code data.

FIG. 3 illustrates a block diagram of an exemplary system that facilitates enforcing a derived concurrency control mechanism to ensure integrity and non-interference between shared resources and a concurrent client.

FIG. 4 illustrates a block diagram of an exemplary system that facilitates implementing the derived concurrency control mechanism as a debugging technique for disparate portions of concurrent control code.

FIG. 5 illustrates a block diagram of exemplary system that facilitates synthesizing a concurrent control mechanism from a sequential proof within a cloud environment.

FIG. 6 illustrates a block diagram of an exemplary system that facilitates automatically identifying regions of concurrent code that require interference protection based upon evaluation of a sequential proof.

FIG. 7 illustrates an exemplary methodology for ensuring non-interference with a shared resource and a concurrent client by leveraging a sequential proof for sequential code to derive concurrent control.

FIG. 8 illustrates an exemplary methodology that facilitates enforcing a derived concurrency control mechanism to ensure integrity and non-interference between shared resources and a concurrent client.

FIG. 9 illustrates an exemplary networking environment, wherein the novel aspects of the claimed subject matter can be employed.

FIG. 10 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “data store,”“engine,” “client,” “interface,” “cloud,” and the like are intended to refer to a computer-related entity, either hardware, software (e.g., in execution), and/or firmware. For example, a component can be a process running on a processor, a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

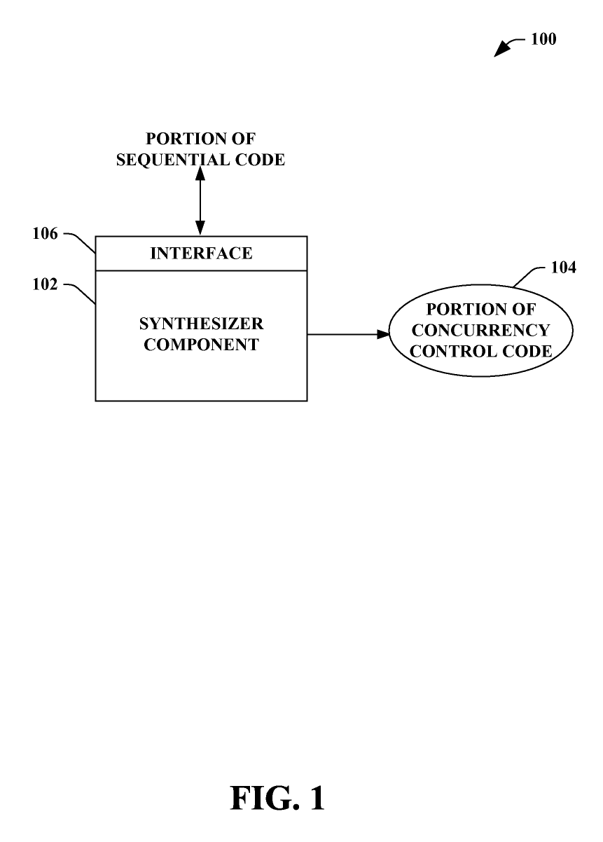

Now turning to the figures, FIG. 1 illustrates a system 100 that facilitates ensuring non-interference between concurrent clients using some shared resource by leveraging a sequential proof for sequential code to derive concurrent control. The system 100 can include a synthesizer component 102 that can receive a portion of sequential code via an interface 106, wherein the synthesizer component 102 can leverage a sequential proof corresponding to the portion of sequential code in order to generate concurrency control that can provide protection against interference between execution threads and shared resources. In particular, the synthesizer component 102 can receive and analyze a sequential proof (e.g., a proof that a thread satisfies a property when executed sequentially) in order to locate an assumption (e.g., related to shared resources, shared data, etc.) that need be maintained at different points during the thread execution. Such analysis (e.g., identifying the property that is maintained), enables the synthesizer component 102 to create concurrency control that protects against potential concurrent interferences for a portion of concurrent code 104

The subject innovation considers the problem of making a sequential library safe for concurrent clients. Informally, given a sequential library that works satisfactorily when invoked by a sequential client, it can be shown how to synthesize concurrency control code for the library that ensures that it will work satisfactorily even when invoked by a concurrent client.

Consider the sequential library illustrated below (Table 1) while ignoring acquire and release operations. The library consists of one procedure Compute, which applies an expensive function f to an input variable num. To avoid repeating the expensive computation on every invocation, the implementation caches the last input and the last result. If the current input matches the last input, the last computed result is returned instead.

TABLE 1

1 global int lastNum = 0, lastRes = f(0);
2 // @requires lastRes == f(lastNum)
3 // @ensures lastRes == f(lastNum)
4 // @ensures lastNum == num
5 // @returns f(num)
6 Compute (num )
7 {
8 acquire (1);
9 if ( lastNum == num ) {
10 res = lastRes ;
11 } else {
12 release (1);
13 res = f( num );
14 acquire (1);
15 lastNum = num;
16 lastRes = res ;
17 }
18 release (1);
19 return res ;
20 }

This procedure works perfectly when used by a sequential client. However, if the procedure is used by a concurrent client, it is possible to have overlapping invocations of the procedure. In this situation, the procedure may return an incorrect answer. E.g., consider an invocation of Compute(5) subsequently followed by the concurrent invocations of Compute(5) and Compute(7). Assume that the second invocation of Compute(5) evaluates the condition in line 9, and proceeds to line 10. Assume a context switch occurs at this point, and the invocation of Compute(7) executes completely, overwriting lastRes in line 16. Now, when the invocation of Compute(5) resumes, it will erroneously return the (changed) value of lastRes.

The concurrency control can be any suitable application of concurrency control mechanism to protect against interference, wherein the concurrency control mechanism can be, but is not limited to being, atomic regions, locks, semaphores, optimistic techniques, pessimistic techniques, two-phase locking, etc. It is to be appreciated that concurrency control is an effect achieved by employing various concurrency control mechanisms which are to be included in the subject innovation. Concurrency control mechanism can be used to signify concurrency control. The former signifies mechanisms such as locks, message passing, etc while the latter signifies the achieved effect in using any of the former mechanisms. The system 100 can identify program locations that form the boundaries of isolation regions, wherein concurrency control can be injected at these locations to ensure isolation. It is to be further appreciated that the subject innovation can be employed with any suitable concurrency control mechanism to affect the required concurrency control (e.g., locks, etc.).

It is to be appreciated that the sequential proof can be received from an entity (e.g., a user, a machine, a server, a website, a link, a network, a data store, an enterprise, etc.), automatically identified based upon an analysis of the portion of sequential code, and/or any suitable combination thereof. For example, a portion of sequential code can include a respective sequential proof in which the synthesizer component 102 leverages in order to derive the concurrency control mechanism. In another example, the synthesizer component 102 can utilize techniques in order to identify a sequential proof for a portion of sequential code, wherein once identified, the synthesizer component 102 can employ the identified sequential proof to synthesize concurrency control.

Recent technology trends point to the increasing importance of concurrency: programs of the future will increasingly be concurrent. But even newly developed systems and programs will need to make heavy use of pre-existing libraries that are too valuable to be just discarded. Unfortunately, libraries that work perfectly well in a sequential setting may fail to work in a concurrent setting due to the use of imperative programming languages with mutable state in the form of global variables or heap-allocated data.

Ensuring that programs function correctly in a concurrent setting requires the use of appropriate concurrency control mechanisms to prevent undesirable interleaving of different threads. However, augmenting a program with the right amount of synchronization that ensures both correctness and high performance is a challenging task.

The subject innovation addresses the problem of automatically making sequential code thread-safe: given some sequential code that works satisfactorily in a sequential setting, concurrency control can be synthesized to ensure that the given piece of code works correctly in a concurrent setting as well Given the code in Table 1, the approach can be to automatically synthesize the locking based concurrency control mechanism (e.g., acquire and release operations with the corresponding locks) shown in the Table. It can be verified that this version of the library works correctly even in the presence of overlapping procedure invocations.

To formalize our problem, the correctness criterion can be formalized for a library: what does it mean to say that a library works correctly in a sequential or concurrent setting? The desired properties of the library can be specified via a set of assertions. Further, library can satisfy these assertions in a sequential setting: e.g., any possible execution of the library, with a sequential client, is assumed to satisfy the given assertions. The goal can be to ensure that any possible concurrent execution of the library also satisfies the given assertions.

For our running example in Table 1, lines 2-5 provide a specification for procedure Compute. Line 5 specifies the desired functionality of the procedure (e.g., Compute returns the value f (num)), while lines 2-4 indicate the invariants about the library's own state that the procedure maintains. In general, the interpretation of pre/post-conditions in a concurrent execution is complicated.

One of the key challenges in coming up with concurrency control is finding the degree of isolation required between concurrently executing threads: what interleavings between threads can be permitted? A conservative solution may prevent more interleavings than necessary; hence, it can reduce the concurrency in the system and affect performance. An aggressive solution focused on enabling more concurrency may introduce subtle bugs (e.g., if it overlooks some undesirable interleaving that produces an incorrect result).

The synthesizer component 102 can employ a thesis as follows: a proof that a piece of sequential code satisfies certain assertions in a sequential execution precisely identifies the properties relied on by the program at different points in execution; hence, such a sequential proof clearly identifies what concurrent interference can be tolerated and what cannot; thus, a correct concurrency control can be systematically (and even automatically) derived from such a proof.

For example, a proof of correctness can be generated in a sequential setting. The program can be presented as a control-flow graph, with its edges representing program statements. A proof can include an invariant attached to every vertex in the control-flow graph. Consider any function μ that maps each vertex of a control-flow graph to a formula. Such an annotation is considered a valid proof if it satisfies the following two conditions: (a) for every edge μ→v labeled with a statement s, execution of s in a state satisfying μ(u) is guaranteed to produce a state satisfying μ(v), and (b) for every edge u→v annotated with an assertion θ, it is the case that θ holds whenever μ(v) holds. Given a specification for a library's or data store's procedures, a verification tool (e.g., discussed in more detail below) can be used to generate such proofs automatically. In general, a proof can be synthesized by the system 300 to create concurrency control code.

The invariant μ(u) attached to a vertex u can indicate the property required (by the proof) to hold at u in order to ensure that the procedure's execution satisfies assertions of the procedure. This can be reinterpreted in a concurrent setting as follows: when a thread t1 is at point u, it can tolerate changes to the state by another thread t2 as long as the invariant μ(u) continues to hold from t1's perspective; but if another thread t2 were to change the state such that invariant μ(u) is broken within t1's perspective, then the continued execution by t1 may fail to satisfy the desired assertions.

Consider Table 2, below. The vertex labeled u in the Table 2 corresponds to the point before the execution of statement [10] (e.g., after the if-condition evaluates to true). The invariant attached to this program point indicates that the proof of correctness depends on the condition2 lastRes==f(num) holding true at this program point. The execution of statement [13] by another thread will not invalidate this condition. On the other hand, execution of statement [16] by another thread can potentially invalidate this condition. Thus, it can be inferred that, when one thread is at point u, a concurrent execution of statement [16] (by another thread) should be avoided.

TABLE 2

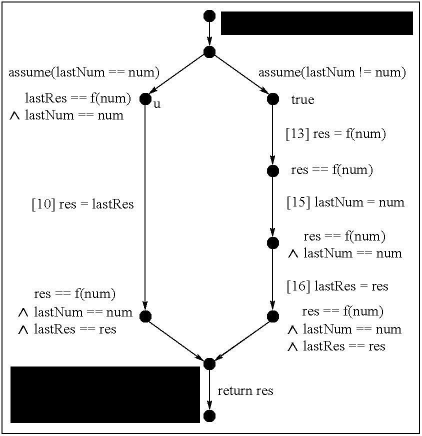

For example, assume the execution of statement s by one thread is to be avoided when another thread is at a program point u as s might invalidate a predicate p that is required at u. This can be ensured this by introducing a lock lockₚ corresponding to p, and ensuring that every thread holds lock lockₚ at program point u and ensuring that every thread acquires and holds lockₚ when executing s. Note that the lock lockₚ does not have to correspond to any specific variable. It is a lock corresponding to a predicate.

The algorithm utilized by the synthesizer component 102 for synthesizing concurrency control does precisely this. From the invariant μ(u) at vertex μ, a set of predicates pm(u) can be computed. For now, think of μ(u) as the conjunction of predicates in pm(u). pm(u) can represent the set of predicates required at u. For any edge u→v, consider any predicate p that is in pm(v) but not in pm(u). It is to be appreciated that pm(v)\m(u) can mathematically denote elements in the set pm(v) but not in the set pm(u). This predicate is required at v but not at u. Hence, the lock for p can be acquired along this edge. Dually, for any predicate that is required at u but not at v, the lock can be released along the edge. Finally, if the execution of the statement in edge u→v can invalidate any predicate p (that is required at some point), the corresponding lock can be acquired and related before and after the statement (unless it is already a required predicate at u or v).

The system 100 ensures that the locking scheme does not introduce any deadlocks by merging locks where necessary, as we will describe later. Finally, the produced solution is optimized solution using a few techniques. E.g., in the example whenever the lock m for lastRes==res is held, the lock 1 for lastNum==num is also held. Hence, the lock m can be eliminated as it is redundant.

Table 1 shows the resulting library with the concurrency control synthesized. It can be seen that this implementation satisfies its specification even in a concurrent setting. The concurrency control inferred permits a high degree to concurrency since it allows multiple threads to compute f concurrently. A more conservative but correct locking scheme would acquire the lock during the entire procedure.

One distinguishing aspect of the algorithm is that it involves very local reasoning. In particular, it does not involve reasoning about interleaved executions, as is common with many analyses of concurrent programs.

In general, the approach outlined above can be used to ensure thread-safety in any of the following senses: permit only interleavings that guarantee certain safety properties (such as the absence of null-pointer dereference) or preserve certain data-structure invariants, or even guarantee that procedures meet their specifications (e.g., given as a precondition/post condition pair).

Existing concurrency control mechanisms rely on a data-access based notion of interference: concurrent access to the same data, where at least one access is a write, is conservatively treated as undesirable interference. This is true of pessimistic concurrency control mechanisms (such as those based on locking), which seek to avoid interference, as well as optimistic concurrency control mechanisms, which seek to detect interference after the fact and rollback. One of the contributions of this subject innovation is that it introduces a more logical/semantic notion of interference and shows that it can be used to achieve more permissive, yet safe, concurrency control. Specifically, concurrency control based on this approach permits interleavings that existing schemes based on stricter notion of interference will disallow. Hand-crafted concurrent code often permits benign interference (e.g., racy accesses to the same data-item) for performance reasons. Formalizing a logical notion of interference, as done in this subject innovation, is useful for this reason (as well as various other reasons).

The approach uses the sequential proof of correctness of procedures for sequential code to generate concurrency control and ensure that every procedure in the code satisfies its specification even in a concurrent setting. Moreover, the system 100 can associate locks with program predicates rather than variables, which can potentially lead to more fine-grained concurrency. Beyond its applications to synthesis and bug finding, the described techniques can serve a mechanism that can be followed to mechanically synthesize concurrency control for sequential code.

In addition, the system 100 can include any suitable and/or necessary interface component 106 (herein referred to as the interface 106), which provides various adapters, connectors, channels, communication paths, etc. to integrate the synthesizer component 102 into virtually any operating and/or database system(s) and/or with one another. In addition, the interface 106 can provide various adapters, connectors, channels, communication paths, etc., that provide for interaction with the synthesizer component 102, the portion of concurrency control code 104, the portion of sequential code, the sequential proof, and any other device and/or component associated with the system 100.

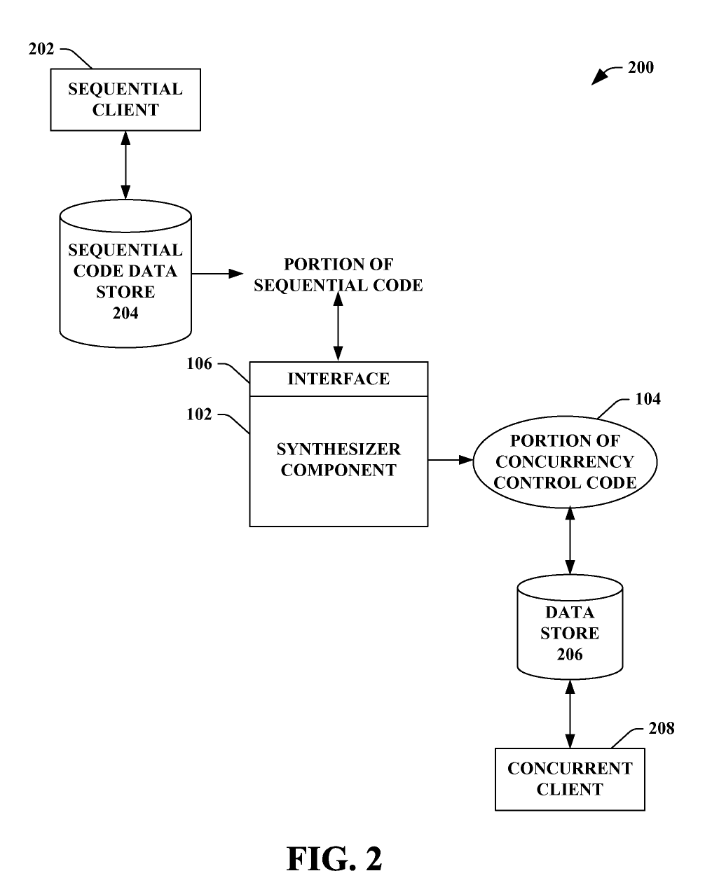

FIG. 2 illustrates a system 200 that facilitates synthesizing concurrency control code for a concurrent client from a collection of sequential code data. The system 200 can include the synthesizer component 102 that enables the employment of sequential code within a concurrent environment or setting without any interference between shared resources, shared data, and/or concurrently executing threads. The synthesizer component 102 can analyze a sequential proof related to sequential code in order to determine potential areas or regions that can interfere when executed concurrently. The sequential proof can provide insight on necessary concurrency control that ensures the thread or code maintains a property when executing concurrently with other threads, clients, and the like.

The system 200 can include the interface 106 that can receive a portion of sequential code, the portion of sequential code includes a property that is maintained and relied upon when invoked and executed by a sequential client. The interface 106 can further receive a proof in which the portion of sequential code satisfies the property during a sequential execution. The synthesizer component 102 can identify, for two or more program points in the portion of sequential code, a set of predicates that are relevant to at such program points. The synthesizer component 102 can determine a type of concurrency control, the type of concurrency control is a lock. The synthesizer component 102 can further insert instructions in the portion of sequential code to manage the concurrency control, the management is at least one of an acquiring of a lock or a releasing of a lock. The synthesizer component 102 can ensure that the lock is held on a predicate at the two or more program points.

The synthesizer component 102 can further provide at least one of the following: an identification of a first instruction in the portion of sequential code whose execution invalidates a relevant predicate; an insertion before the first instruction a second instruction for acquiring the lock corresponding to the relevant predicate unless the lock corresponds to a predicate relevant at the respective program point before the first instruction; or an insertion after the first instruction a third instruction for releasing the lock corresponding to the relevant predicate unless the lock corresponds to a predicate relevant at the respective program point after the first instruction.

The synthesizer component 102 can further utilize a second portion of sequential code that access a portion of shared data related to the portion of sequential code in order to provide at least one of the following: an identification of a first instruction in the second portion of sequential code whose execution invalidates a relevant predicate; an insertion before the first instruction a second instruction for acquiring the lock corresponding to the relevant predicate; or an insertion after the first instruction a third instruction for releasing the lock corresponding to the relevant predicate.

Moreover, the synthesizer component 102 can analyze the portion of sequential code and a specification of one or more desired properties in order to employ a verification technique to generate the proof that the portion of sequential code satisfies the specification in a sequential execution, the synthesizer component 102 utilizes the portion of the code and the proof to insert instructions to provide concurrency control.

In accordance with an aspect of the subject innovation, the synthesizer component 102 can enable a data store 204 or library of sequential code to be adapted for implementation with a concurrent environment, setting, or client. For instance, given a sequential library or data store 204 that works satisfactorily when invoked by a sequential client 202, the system 200 can synthesize concurrency control code 104 that ensures that it will work satisfactorily when invoked by a concurrent client 208. The sequential library or data store 204 can include annotated assertions that hold true when the library or data store 204 is invoked by the sequential client 202. A corresponding sequential proof for the assertions can be constructed or received, wherein the synthesizer component 102 can utilize the sequential proof to derive a concurrency control for the sequential code, the library, and/or the data store 204. This concurrency control can ensure that the library and/or data store 204 execution can satisfy the same assertions even when invoked by the concurrent client 208.

The system 200 can create the concurrency control based upon locks that can be associated with a predicate about a program state. The system 200 can further consider assertions that correspond to relations over a pair of program states. Such assertions can be used (e.g., as post conditions) to specify desired functionality of procedures. Thus, the synthesized concurrency control derived from the sequential proof ensures that procedures have the desired functionality in a concurrent setting, environment, and/or client (e.g., concurrent client 208).

The system 200 can automatically make sequential code thread-safe given a portion of sequential code that works satisfactorily in a sequential setting. The synthesizer component 102 can synthesize concurrency control that ensures that the given piece of code works correctly in a concurrent setting as well. In other words, a portion of sequential code can be automatically and systematically adapted to a concurrent setting or environment based upon generating concurrency control (e.g., leveraging the sequential proof) to apply to the code to prevent interference between shared resources, data, or threads when executed concurrently—this can be the portion of concurrency control code 104.

The system 200 can include the data store 204 and/or the data store 206 that can include any suitable data utilized and/or accessed by the synthesizer component 102, the interface 106, the portion of concurrency control code 104, the sequential client 202, the concurrent client 208, the sequential proof, etc. For example, the data store 204 or the data store 206 can include, but not limited to including, sequential code, sequential proof, properties of sequential data, thread information, adapted sequential data for concurrency execution, concurrency control code, concurrency control mechanisms, derived control mechanisms, etc. Moreover, although the data store 204 and/or the data store 206 are depicted as stand-alone components, it is to be appreciated that the data store 204 and/or the data store 206 can be stand-alone components, incorporated into the synthesizer component 102, the sequential client 202, the concurrent client 208, and/or any suitable combination thereof

It is to be appreciated that the data store 204 and/or the data store 206 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 204 and/or the data store 206 of the subject systems and methods is intended to comprise, without being limited to, these and any other suitable types of memory. In addition, it is to be appreciated that the data store 204 and/or the data store 206 can be a server, a database, a hard drive, a pen drive, an external hard drive, a portable hard drive, and the like.

The input to the technique employed by the synthesizer component 102 can include (sequential) code (referenced herein as “C”) corresponding to a single thread, along with a (sequential) proof for this thread. The proof can be expressed in terms of predicates, wherein the predicates can be simple or compound. A compound predicate can be a Boolean expression consisting of disjunction (OR), conjunction (AND), and negation (NOT) operators applied to simple predicates. A simple predicate captures conditions satisfied by data, such as “X==Y” (which means that the value of program variables X and Y are equal). The proof can include a predicate associated with every program-point in the code C. The proof can satisfy the usual semantics of the sequential program statements. In other words, for any simple statement (referenced herein by “s”) in code C, if the proof includes a predicate “p1” associated with the program-point before s and a predicate “p2” with the program-point after s, then it must be the case that executing statement s in a state satisfying condition p1 produces a state satisfying condition p2.

The data that is intended to be shared can be assumed to be encapsulated in a module (referenced herein by “M”), consisting of a set of methods for accessing and updating the shared data. Other code cannot access shared data directly. The other code may access shared data through the methods of module M. For any predicate “p” and method “m,”, m can preserve p if the invocation of m in a state that satisfies p produces a state that satisfies p. Otherwise, m may break p (e.g., interference, error, complication, etc.). For a predicate p used in the proof, and a method m in M, m can be analyzed to determine if m preserves p or if m may break p. Consider a statement s in code C with a predicate p1 associated with the program-point before s and a predicate p2 associated with the program-point after s. It can be determined that s establishes a predicate p if p2 implies p and p1 does not imply p.

The statements in code C can be analyzed to determine the predicates that are established. Consider a statement s in code C with a predicate p1 associated with the program-point before s and a predicate p2 associated with the program-point after s. The statement s may not use a simple predicate p if establishing that p2 holds after the execution of s does not require p to hold before s executes. More formally, the synthesizer component 102 can define an operation havoc (p1, p) that removes an assumption about p from p1 as follows: convert p1 into DNF, and remove an occurrence of p from a term in this DNF, producing the result predicate. It can be established that s does not use a simple predicate p if executing s in any state satisfying havoc (p1, p) produces a state satisfying p2. Otherwise, it can be established that s uses p. The statements in code C can be analyzed to determine the simple predicates each statement uses. A concurrency control mechanism (e.g., such as a lock) can be introduced for each simple predicate p in the proof that may be broken by a method of module M. Any module method that can break a simple predicate p can acquire/release the corresponding lock at entry/exit of the procedure.

The proof can be examined to determine at least one lifetime of the shared predicate invariants (e.g., find points within the code where the shared predicate is established, and where it is used). It is to be appreciated that the lifetime can be identified by using any suitable analysis technique. In a specific example, if a Boolean-program representation of the program is used, with Boolean variables corresponding to predicates, then predicate lifetimes can be determined by computing the reaching definitions for uses of Boolean variables. The corresponding concurrency control mechanism can be acquired before the statement where the predicate is established, and released when the predicate is no longer required (by the proof).

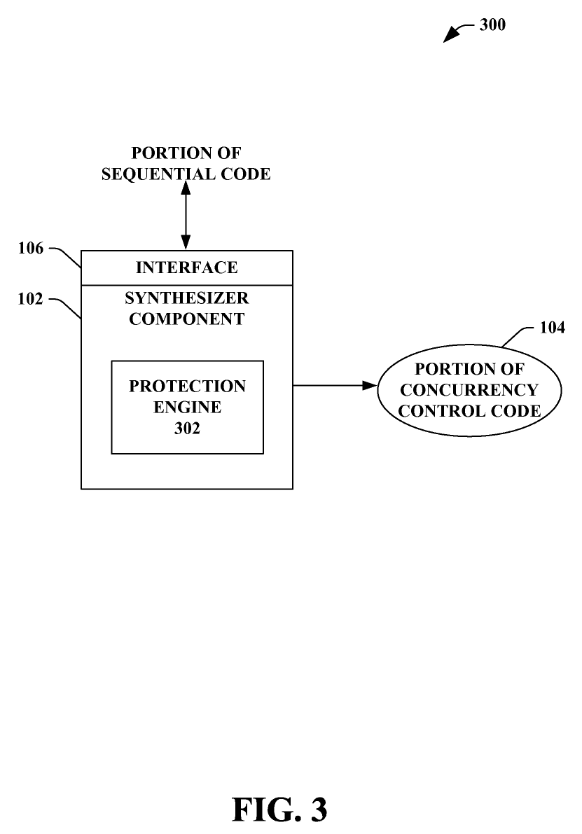

FIG. 3 illustrates a system 300 that facilitates enforcing a derived concurrency control mechanism to ensure integrity and non-interference between shared resources and a concurrent client. The system 300 can include the synthesizer component 102 that can analyze a sequential proof related to a portion of sequential code in order to identify locations or point within the code that can be protected by a concurrency control mechanism in order for such code to be utilized with a concurrent client. In other words, the system 300 can ensure a portion of sequential code can be adapted or manipulated with placement of concurrency control mechanisms to enable the code to be utilized in a concurrent environment or setting-providing a portion of concurrency control code 104.

The synthesizer component 102 can include a protection engine 302 that can evaluate the ascertained predicates for a portion of sequential code in order to identify a suitable concurrency control mechanism. In addition, the protection engine 302 can enforce the identified concurrency control for the code in order to ensure such code can be executed as concurrency control code 104 within a concurrent client. In other words, the protection engine 302 can identify a concurrency control mechanism and enforce such mechanism at specific points within the execution of the code. It is to be appreciated that the protection engine 302 can employ any suitable concurrency control mechanism such as, but not limited to, atomic regions, locks, semaphores, optimistic techniques, pessimistic techniques, two-phase locking, etc.

In particular, the protection engine 302 can identify how execution of methods of shared data can affect assumptions (e.g., property, predicate, etc.) identified from a sequential proof The protection engine 302 can further determine a set of locks to protect such assumptions, wherein such locks can be held for the method to execute as part of a concurrency control protocol. The protection engine 302 can further identify places in the code where different locks need to be acquired and released as part of the concurrency control protocol.

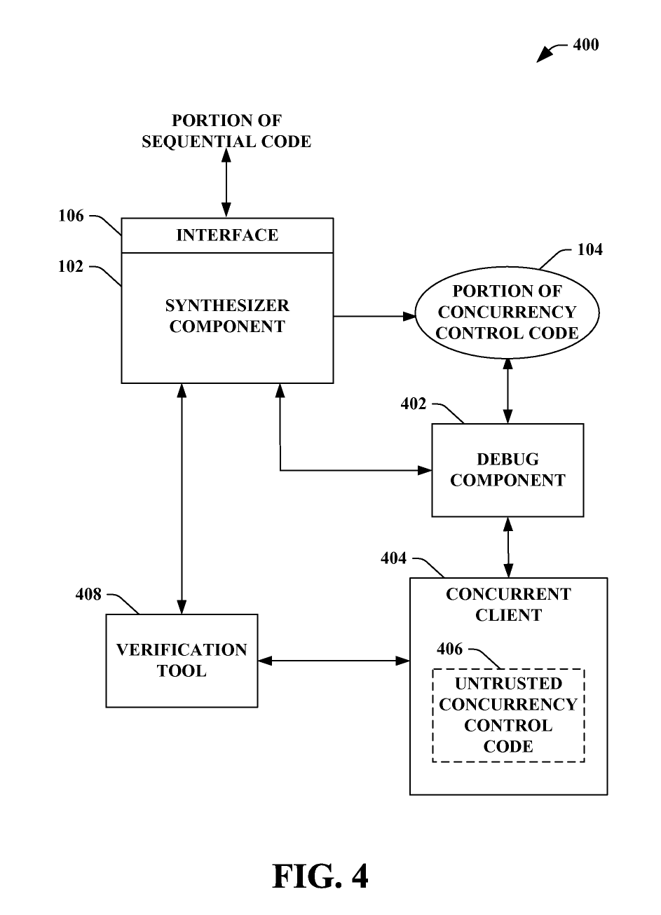

FIG. 4 illustrates a system 400 that facilitates implementing the derived concurrency control mechanism as a debugging technique for disparate portions of concurrent control code. The system 400 can include the synthesizer component 102 that can adapt sequential code received via the interface 106 to concurrent control code 104 based upon a sequential proof. In general, a portion of sequential code and corresponding sequential proof can be analyzed in order to identify predicates that are maintained during sequential execution. Such predicates or properties can be identified as potential threats or interference regions for the sequential code if such code where to be implemented in a concurrent setting or environment. Thus, the synthesizer component 102 can provide such analysis and identification of sequential code regions or areas that can be problematic if executed in a concurrent environment, setting, or client.

The system 400 can further include a debug component 402 that can leverage the analysis and identification of problem areas or regions within sequential code in order to debug or check existing or created concurrency control code. In particular, the debug component 402 can check or debug a portion of un-trusted concurrency control code 406 utilized by a concurrent client 404. For instance, a portion of concurrency control code can be verified or checked for interference or conflicts by the debug component 402 and the derived concurrent control mechanism and placement of such mechanism. In another example, the debug component 402 can be utilized as a bug-finding tool that can locate potential errors in the code, program, etc.

Moreover, a verification tool 408 can be utilized with the system 400. The verification tool 408 can be combined or utilized in connection with the synthesizer component 102 in order to generate a proof. In other words, the verification tool 408 can create or facilitate creating or identifying a sequential proof that can be implemented in order to derive concurrency control mechanisms and or points within code or data that such concurrency control mechanisms can be employed in a concurrency environment.

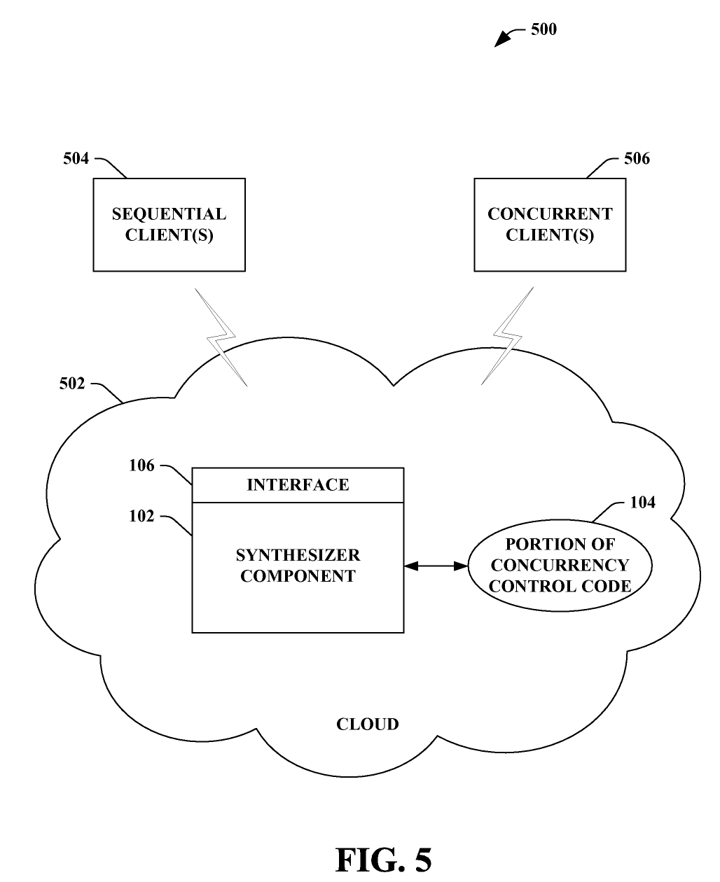

FIG. 5 illustrates a system 500 that facilitates synthesizing a concurrent control mechanism from a sequential proof within a cloud environment. It is to be appreciated that the system 500 can be service-based, cloud-based, distributed, monolithic, etc. The system 500 can utilize a cloud 502 that can incorporate at least one of the synthesizer component 102, the portion of sequential code, the portion of concurrency control code 104, the interface 106, a sequential proof, and/or any suitable combination thereof. It is to be appreciated that the cloud 502 can include any suitable component, device, hardware, and/or software associated with the subject innovation. The cloud 502 can refer to any collection of resources (e.g., hardware, software, combination thereof, etc.) that are maintained by a party (e.g., off-site, on-site, third party, etc.) and accessible by an identified user over a network (e.g., Internet, wireless, LAN, cellular, Wi-Fi, WAN, etc.). The cloud 502 is intended to include any service, network service, cloud service, collection of resources, etc. and can be accessed by an identified user via a network. For instance, two or more users can access, join, and/or interact with the cloud 502 and, in turn, at least one of the synthesizer component 102, the portion of sequential code, the portion of concurrency control code 104, the interface 106, a sequential proof, and/or any suitable combination thereof. In addition, the cloud 502 can provide any suitable number of service(s) to any suitable number of user(s) and/or client(s). In particular, the cloud 502 can include resources and/or services that can allow sequential code to be adapted to be utilized with concurrent clients based upon developing concurrent control mechanisms from a sequential proof.

Generally, the cloud 502 can provide a communications environment or network for any suitable number of users, clients, and the like. In other words, the cloud 502 can be a secure and informative community or forum in which users or clients can submit, share, and/or receive sequential code, concurrency control code, concurrency control mechanisms, sequential proofs, etc. Moreover, as a forum, the cloud 502 can enable two or more users or clients to communicate (e.g., text, chat, video, audio, instant message, etc.). In addition, the cloud 502 can implement an administrator that can monitor, regulate, and/or provide assistance in relation to users and/or activity. For instance, the cloud 502 can be a networked community, a forum, and the like.

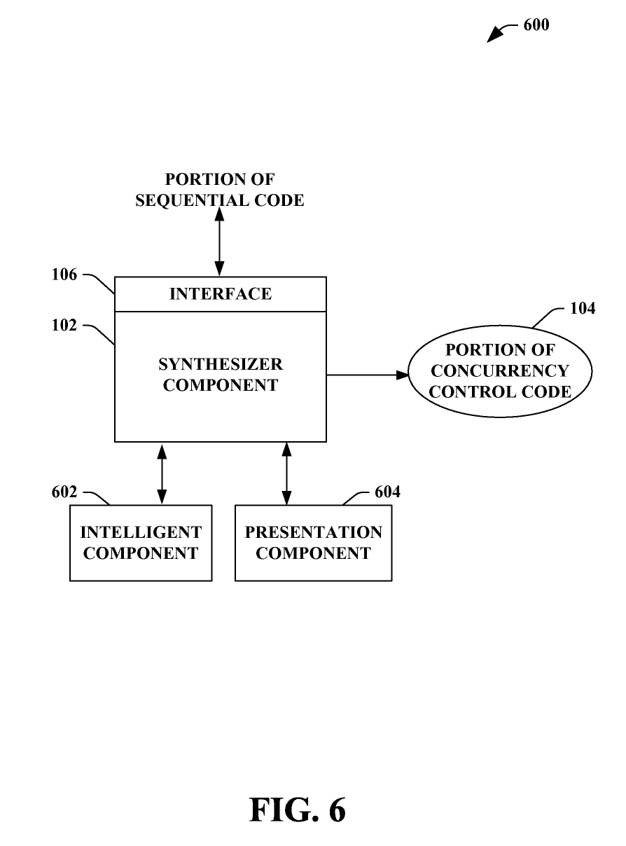

FIG. 6 illustrates a system 600 that employs intelligence to facilitate automatically identifying regions of concurrent code that require interference protection based upon evaluation of a sequential proof. The system 600 can include the synthesizer component 102, the portion of concurrency code 104, the interface 106, and the portion of sequential code, which can be substantially similar to respective components, concurrency code, interfaces, and portions of sequential code described in previous figures. The system 600 further includes an intelligent component 602. The intelligent component 602 can be utilized by the synthesizer component 102 to facilitate generating concurrency control code with at least one concurrency control mechanism derived from a portion of sequential code and respective sequential proof. For example, the intelligent component 602 can infer concurrency control mechanisms to employ, locations or regions to initiate concurrency control mechanisms, potential errors or interferences with sequential code employed as concurrent control code, sequential proofs, predicates for a portion of sequential code, a property that is to be maintained during execution of sequential code, locations of where a predicate or property is to be maintained during sequential execution, etc.

The intelligent component 602 can employ value of information (VOI) computation in order to identify concurrency control mechanisms. For instance, by utilizing VOI computation, the most ideal and/or appropriate concurrent control mechanism for a portion of code can be determined. Moreover, it is to be understood that the intelligent component 602 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

The synthesizer component 102 can further utilize a presentation component 604 that provides various types of user interfaces to facilitate interaction between a user and any component coupled to the synthesizer component 102. As depicted, the presentation component 604 is a separate entity that can be utilized with the synthesizer component 102. However, it is to be appreciated that the presentation component 604 and/or similar view components can be incorporated into the synthesizer component 102 and/or a stand-alone unit. The presentation component 604 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into the synthesizer component 102.

The user can also interact with the regions to select and provide information via various devices such as a mouse, a roller ball, a touchpad, a keypad, a keyboard, a touch screen, a pen and/or voice activation, a body motion detection, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can then provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, EGA, VGA, SVGA, etc.) with limited graphic support, and/or low bandwidth communication channels.

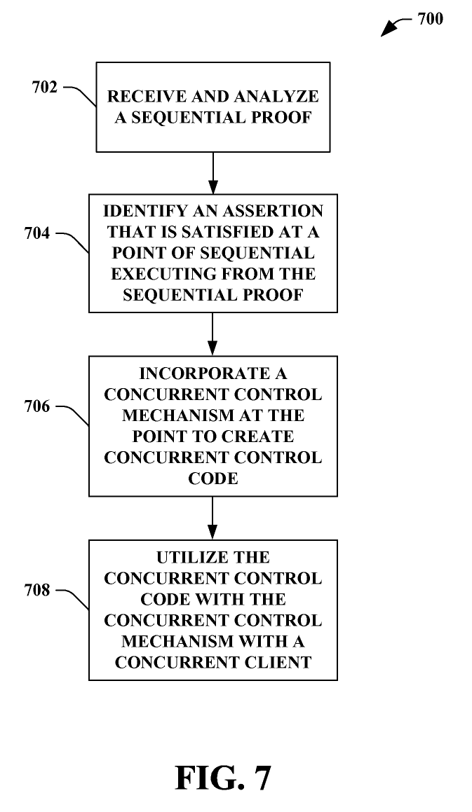

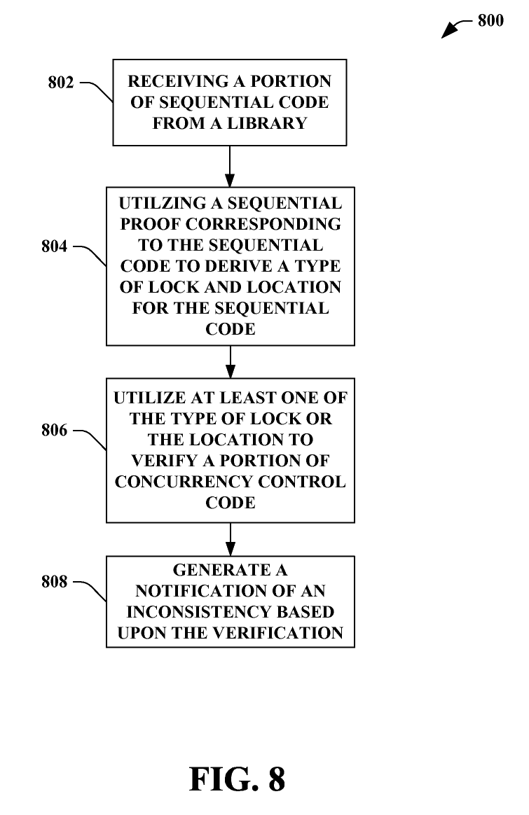

FIGS. 7-8 illustrate methodologies and/or flow diagrams in accordance with the claimed subject matter. For simplicity of explanation, the methodologies are depicted and described as a series of acts. It is to be understood and appreciated that the subject innovation is not limited by the acts illustrated and/or by the order of acts. For example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 7 illustrates a method 700 that facilitates ensuring non-interference with a shared resource and a concurrent client by leveraging a sequential proof for sequential code to derive concurrent control. At reference numeral 702, a sequential proof can be received and analyzed. It is to be appreciated that the sequential proof can correspond to a portion of sequential code and can be received by any suitable entity. In another instance, the sequential proof can be ascertained based upon evaluation of the portion of sequential code.

At reference numeral 704, an assertion that is satisfied at a point of sequential execution can be identified from the sequential proof. At reference numeral 706, a concurrent control mechanism can be incorporated at the point to create concurrent control code. It is to be appreciated that the concurrent control mechanism can be, but is not limited to being, atomic regions, locks, semaphores, optimistic techniques, pessimistic techniques, two-phase locking, etc. At reference numeral 708, the concurrent control code can be utilized with the concurrent control mechanism with a concurrent client (e.g., entity, environment setting, etc.).

FIG. 8 illustrates a method 800 for enforcing a derived concurrency control mechanism to ensure integrity and non-interference between shared resources and a concurrent client. At reference numeral 802, a portion of sequential code can be received from a library (e.g., a data store, etc.). At reference numeral 804, a sequential proof corresponding to the sequential code can be utilized to derive a type of lock and location for the sequential code. In particular, the sequential proof can identify a predicate that is to be maintained at a particular sequential execution point-in which such predicate can indicate a lock to be utilized at such execution point.

At reference numeral 806, at least one of the type of lock or the location can be utilized to verify a portion of concurrency control code. The verification can enable the concurrency control mechanisms within a first portion of concurrency control code to be checked with the locks derived from the sequential proof. At reference numeral 808, a notification of an inconsistency can be generated based upon the verification. It is to be appreciated that such notification can be utilized to debug or check a portion of concurrency control code.

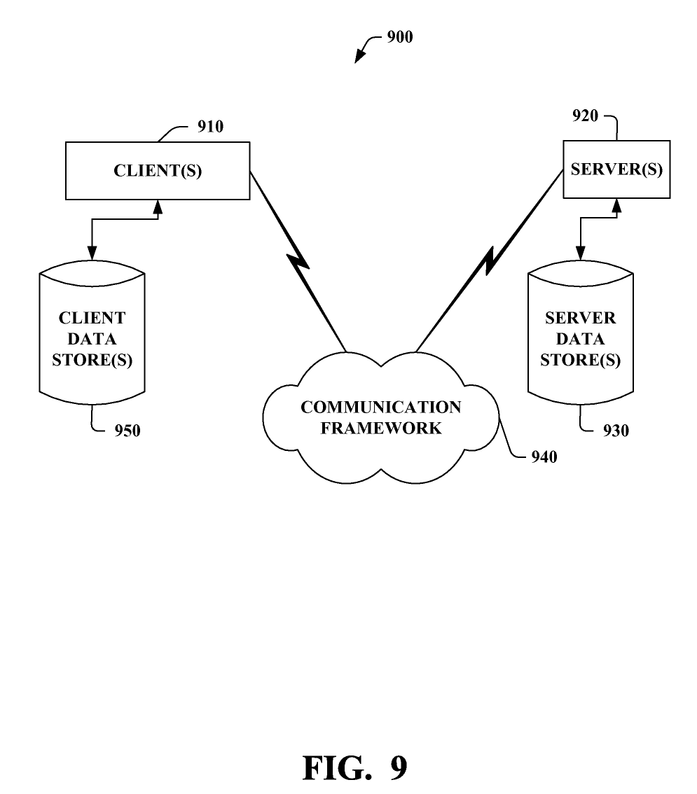

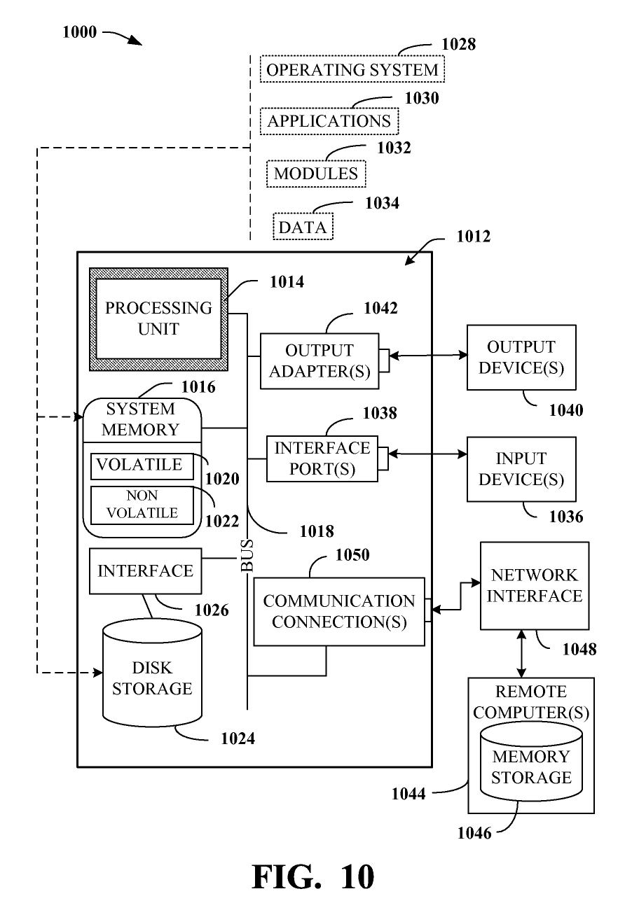

In order to provide additional context for implementing various aspects of the claimed subject matter, FIGS. 9-10 and the following discussion is intended to provide a brief, general description of a suitable computing environment in which the various aspects of the subject innovation may be implemented. For example, a synthesizer component that generates a concurrency control mechanism by evaluating a sequential proof, as described in the previous figures, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 9 is a schematic block diagram of a sample-computing environment 900 with which the claimed subject matter can interact. The system 900 includes one or more client(s) 910. The client(s) 910 can be hardware and/or software (e.g., threads, processes, computing devices). The system 900 also includes one or more server(s) 920. The server(s) 920 can be hardware and/or software (e.g., threads, processes, computing devices). The servers 920 can house threads to perform transformations by employing the subject innovation, for example.

One possible communication between a client 910 and a server 920 can be in the form of a data packet adapted to be transmitted between two or more computer processes. The system 900 includes a communication framework 940 that can be employed to facilitate communications between the client(s) 910 and the server(s) 920. The client(s) 910 are operably connected to one or more client data store(s) 950 that can be employed to store information local to the client(s) 910. Similarly, the server(s) 920 are operably connected to one or more server data store(s) 930 that can be employed to store information local to the servers 920.

With reference to FIG. 10, an exemplary environment 1000 for implementing various aspects of the claimed subject matter includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), or flash memory. Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 also includes removable/non-removable, volatile/non-volatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in the suitable operating environment 1000. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the claimed subject matter can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

There are multiple ways of implementing the present innovation, e.g., an appropriate API, tool kit, driver code, operating system, control, standalone or downloadable software object, etc. which enables applications and services to use the advertising techniques of the invention. The claimed subject matter contemplates the use from the standpoint of an API (or other software object), as well as from a software or hardware object that operates according to the advertising techniques in accordance with the invention. Thus, various implementations of the innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system that facilitates ensuring non-interference between concurrent clients that share some resource, comprising:
an interface that receives a portion of sequential code, the portion of sequential code includes a property that is maintained and relied upon when invoked and executed by a sequential client;
the interface receives a proof that the portion of sequential code satisfies the property during a sequential execution;
a synthesizer component that identifies, for two or more program points in the portion of sequential code, a set of predicates that are relevant at such program points;
the synthesizer component determines a type of concurrency control, the type of concurrency control is a lock and is associated with each predicate within the set of predicates identified;
the synthesizer component inserts instructions in the portion of sequential code to manage the concurrency control, the management is at least one of an acquiring of a lock or a releasing of a lock; and
the synthesizer component ensures that the lock is held on a predicate at the two or more program points, the locks correspond to the predicates relevant at the two or more program points.

2. The system of claim 1, further comprising at least one of the following:
the synthesizer component identifies a first instruction in the portion of sequential code whose execution invalidates a relevant predicate;
the synthesizer component inserts before the first instruction a second instruction for acquiring the lock corresponding to the relevant predicate unless the lock corresponds to a predicate relevant at the respective program point before the first instruction; or
the synthesizer component inserts after the first instruction a third instruction for releasing the lock corresponding to the relevant predicate unless the lock corresponds to a predicate relevant at the respective program point after the first instruction.

3. The system of claim 1, further comprising at least one of the following:
a second portion of sequential code that access a portion of shared data related to the portion of sequential code;
the synthesizer component identifies a first instruction in the second portion of sequential code whose execution invalidates a relevant predicate;
the synthesizer component inserts before the first instruction a second instruction for acquiring the lock corresponding to the relevant predicate; or
the synthesizer component inserts after the first instruction a third instruction for releasing the lock corresponding to the relevant predicate.

4. The system of claim 1, the synthesizer component analyzes the portion of sequential code and a specification of one or more desired properties in order to employ a verification technique to generate the proof that the portion of sequential code satisfies the specification in a sequential execution, the synthesizer component utilizes the portion of the code and the proof to insert instructions to provide concurrency control.

5. The system of claim 1, further comprising a protection component that identifies a type of concurrency control mechanism to employ specific to a target concurrent client.

6. The system of claim 5, the protection component employs the type of concurrency control mechanism on a region corresponding to the execution point of the property for the portion the sequential code to create the portion of concurrency control code that executes in the concurrent client without an interference with the shared resource.

7. The system of claim 6, the sequential proof corresponds to a thread, the protection component implements the concurrency control mechanism to the execution point in order to create the concurrent control code.

8. The system of claim 1, further comprising a debug component that utilizes the derived concurrency control mechanism to check for consistent incorporation of concurrency control mechanisms at an execution point within a second portion of concurrency control code.

9. The system of claim 8, the debug component generates a notification based upon an inconsistency in regards to the comparison between the derived concurrent control mechanism and a concurrent control mechanism implemented by the second portion of concurrency code.

10. The system of claim 8, the debug component generates a notification related to an identified inconsistency in regards to the comparison between the execution point identified by the synthesizer component and an execution point for the concurrent control mechanism related to the second point of concurrency code.

11. The system of claim 8, the debug component automatically incorporated the derived concurrency control mechanism over the concurrency control mechanism in light of a detected inconsistency.

12. The system of claim 1, further comprising a verification tool that automatically identifies or generates the sequential proof based upon an analysis of the portion of sequential proof.

13. The system of claim 12, the verification tool receives the sequential proof from an entity and automatically communicates the sequential proof to the interface.

14. The system of claim 13, the entity is at least one of a user, a machine, a server, a website, a link, a network, a data store, or an enterprise.

15. The system of claim 1, further comprising a data store that includes a plurality of the portion of sequential code.

16. The system of claim 15, the synthesizer component adapts the data store and the plurality of the portion of sequential code in order to be utilized in a concurrent environment without an interference with a shared resource.

17. A computer-implemented method that facilitates automatically creating concurrency control code, comprising:
receiving a sequential proof;
analyzing the sequential proof;
identifying an assertion that is satisfied at a point of sequential execution from the sequential proof;
incorporating concurrency control at the point to create concurrent control code; and
utilizing the concurrent control code including the concurrent control with a concurrent client.

18. The method of claim 17, further comprising:
utilizing the sequential proof corresponding to the sequential code to derive a type of lock and a location for the sequential code;
utilizing at least one of the type of lock or the location to verify a portion of concurrency control code; and
generate a notification of an inconsistency based upon the verification.

19. The method of claim 17, the concurrency control is at least one of an atomic region, a lock, a semaphore, an optimistic technique, a pessimistic technique, or a two-phase locking.

20. A computer-implemented system that facilitates ensuring non-interference between concurrent clients that share a resource, comprising:
means for receiving a portion of sequential code, the portion of sequential code includes a property that is maintained and relied upon when invoked and executed by a sequential client;
means for leveraging a sequential proof related to the portion of sequential code in order to derive concurrency control for a portion of concurrency control code that maintains the property when invoked by a concurrent client;
means for utilizing the sequential proof to identify a concurrent interference at an execution point that is tolerable for the concurrent client;
means for enforcing the concurrency control systematically and automatically derived from the sequential proof enabling the concurrent client to utilize the portion of concurrency control code without an interference involving a shared resource; and
means for utilizing the derived concurrency control to debug a disparate portion of concurrency control code.
